(19) United States
(12) Patent Application Publication
(10) Pub. No.: US 2021/0349450 A1
(43) Pub. Date: Nov. 11, 2021

(54) HIERARCHICAL ASSESSMENT OF PROCESSES FOR IMPLEMENTING ROBOTIC PROCESS AUTOMATION

(71) Applicant: UiPath, Inc., New York, NY (US)

(72) Inventors: Ana-Maria Oana CINCA, Chitila (RO); Iulia ISTRATE, Bucharest (RO); Maura Cristina CHIRIAC, Bucharest (RO); Alexandru STATIE, Bucharest (RO); Mihai-Valentin BUCUR, Ploiesti (RO)

(73) Assignee: UiPath, Inc., New York, NY (US)

(21) Appl. No.: 16/867,941

(22) Filed: May 6, 2020

(51) Int. Cl. G05B 19/418; G05B 23/02

(52) U.S. Cl. CPC G05B 19/4188; G05B 23/0283; G05B 19/4183

(57) ABSTRACT

Systems and methods for performing a hierarchical assessment of a process for implementing robotic process automation (RPA) for automating the process are provided. An initial assessment of a suitability and a readiness of implementing RPA to automate the process is performed. In response to a determination to continue the hierarchical assessment based on results of the initial assessment, a detailed assessment of an estimated benefit and an estimated ease of implementing RPA to automate the process is performed. In response to a determination to continue the hierarchical assessment based on results of the detailed assessment, a cost benefit assessment is performed to determine a number of RPA robots to deploy to perform the process. The process is performed using the number of the RPA robots.

### TECHNICAL FIELD

The present invention relates generally to robotic process automation, and more particularly to the hierarchical assessment of processes for determining whether to implement robotic process automation for automating the processes.

### BACKGROUND

Processes are sequences of activities executed to provide products or services. Robotic process automation (RPA) is a form of process automation that uses software robots to automate such processes. RPA may be implemented to automate repetitive and/or labor-intensive processes, with the goal of reducing costs, increasing productivity, or increasing quality. However, it is often difficult for organizations to determine whether implementing RPA to automate a particular process will, in practice, reduce costs and by how much. Conventionally, algorithms are applied to determine whether to implement RPA to automate processes. However, such conventional algorithms are not sufficiently accurate.

### BRIEF SUMMARY OF THE INVENTION

In accordance with one or more embodiments, systems and methods for performing a hierarchical assessment of a process for implementing robotic process automation (RPA) for automating the process are provided. An initial assessment of a suitability and a readiness of implementing RPA to automate the process is performed. In response to a determination to continue the hierarchical assessment based on results of the initial assessment, a detailed assessment aimed at providing an estimated benefit, automation potential, and ease of implementing RPA to automate the process is performed. In response to a determination to continue the hierarchical assessment based on results of the detailed assessment, a cost benefit assessment is performed to determine a number of RPA robots to deploy to perform the process. The process is implemented and performed using the number of the RPA robots.

In one embodiment, the detailed assessment is performed by calculating an amount of time saved by estimating the ease of implementing RPA to automate the process as one of a plurality of categories, estimating an automation potential representing a percentage of the process than can be automated, and estimating an amount of time saved by automating the process and cost saved by automating the process based on the estimated automation potential. The amount of time saved by automating the process is estimated as a product between the estimated automation potential and a time to manually perform the process. The cost saved by automating the process is calculated as a product of the amount of time saved by automating the process and a cost of a user to manually perform the process. In one embodiment, the detailed assessment determines to not implement RPA to automate the process based on a severity of expected changes to the process or to applications running the process.

In one embodiment, the initial assessment determines to not implement RPA to automate the process based on data input into the process not being digital.

In one embodiment, the cost benefit assessment determines the number of RPA robots based on inputs and outputs of the detailed assessment and user inputs.

In one embodiment, a dashboard of results of one or more of the initial assessment, the detailed assessment, and the cost benefit assessment is displayed. The dashboard may display a table of results of the detailed assessment for a set of processes including the process, wherein the set of processes in the table are grouped into groups based on automation goal and, within each group, the set of processes grouped into sub-groups based on functional area.

These and other advantages of the invention will be apparent to those of ordinary skill in the art by reference to the following detailed description and the accompanying drawings.

### BRIEF DESCRIPTION OF THE DRAWINGS

FIG. 1 is an architectural diagram illustrating a robotic process automation (RPA) system, according to an embodiment of the invention;

FIG. 2 is an architectural diagram illustrating an example of a deployed robotic process automation system, according to an embodiment of the invention;

FIG. 3 is an architectural diagram illustrating a simplified deployment example of a robotic process automation system, according to an embodiment of the invention;

FIG. 4 shows a method for performing a hierarchical assessment for implementing RPA for automating a process, in accordance with one or more embodiments of the invention;

FIG. 5 shows an exemplary user interface for displaying results of an initial assessment, in accordance with one or more embodiments of the invention;

FIG. 6 shows an exemplary dashboard for displaying results of a detailed assessment, in accordance with one or more embodiments of the invention;

FIG. 7 shows an exemplary dashboard for displaying a table of results of the detailed assessment, in accordance with one or more embodiments of the invention; and

FIG. 8 is a block diagram of a computing system according to an embodiment of the invention.

### DETAILED DESCRIPTION

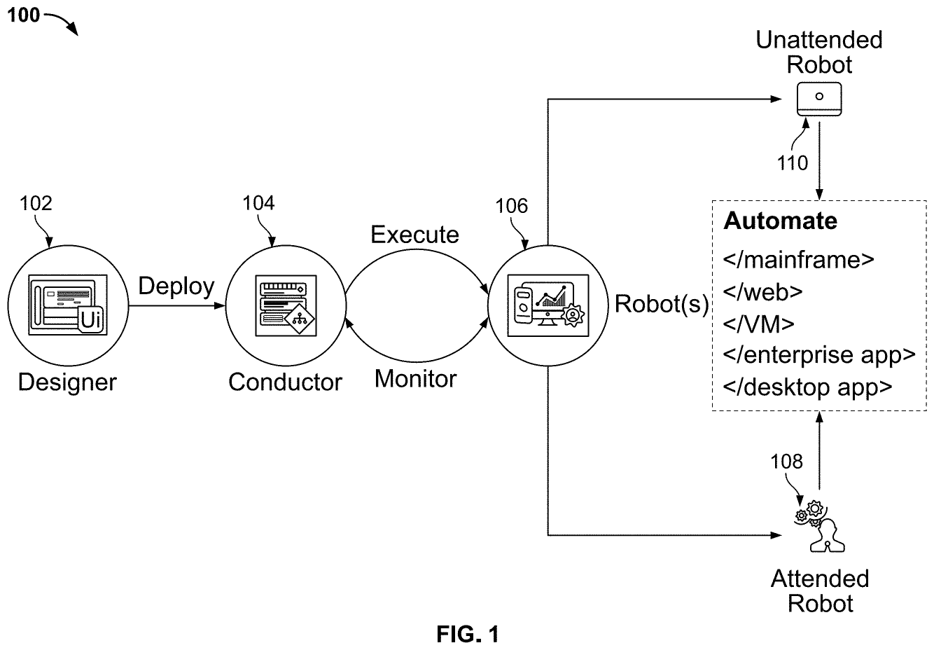

Robotic process automation (RPA) is used for automating processes. FIG. 1 is an architectural diagram of an RPA system 100, in accordance with one or more embodiments. As shown in FIG. 1, RPA system 100 includes a designer 102 to allow a developer to design automation processes. More specifically, designer 102 facilitates the development and deployment of RPA processes and robots for performing activities in the processes. Designer 102 may provide a solution for application integration, as well as automating third-party applications, administrative Information Technology (IT) tasks, and business processes for contact center operations. One commercial example of an embodiment of designer 102 is UiPath Studio™.

In designing the automation of rule-based processes, the developer controls the execution order and the relationship between a custom set of steps developed in a process, defined herein as “activities.” Each activity may include an action, such as clicking a button, reading a file, writing to a log panel, etc. In some embodiments, processes may be nested or embedded.

Some types of processes may include, but are not limited to, sequences, flowcharts, Finite State Machines (FSMs), and/or global exception handlers. Sequences may be particularly suitable for linear processes, enabling flow from one activity to another without cluttering a process. Flowcharts may be particularly suitable to more complex business logic, enabling integration of decisions and connection of activities in a more diverse manner through multiple branching logic operators. FSMs may be particularly suitable for large workflows. FSMs may use a finite number of states in their execution, which are triggered by a condition (i.e., transition) or an activity. Global exception handlers may be particularly suitable for determining workflow behavior when encountering an execution error and for debugging processes.

Once a process is developed in designer 102, execution of business processes is orchestrated by a conductor 104, which orchestrates one or more robots 106 that execute the processes developed in designer 102. One commercial example of an embodiment of conductor 104 is UiPath Orchestrator™. Conductor 220 facilitates management of the creation, monitoring, and deployment of resources in an RPA environment. In one example, conductor 104 is a web application. Conductor 104 may also function as an integration point with third-party solutions and applications.

Conductor 104 may manage a fleet of RPA robots 106 by connecting and executing robots 106 from a centralized point. Conductor 104 may have various capabilities including, but not limited to, provisioning, deployment, configuration, queueing, monitoring, logging, and/or providing interconnectivity. Provisioning may include creation and maintenance of connections between robots 106 and conductor 104 (e.g., a web application). Deployment may include assuring the correct delivery of package versions to assigned robots 106 for execution. Configuration may include maintenance and delivery of robot environments and process configurations. Queueing may include providing management of queues and queue items. Monitoring may include keeping track of robot identification data and maintaining user permissions. Logging may include storing and indexing logs to a database (e.g., an SQL database) and/or another storage mechanism (e.g., ElasticSearch®, which provides the ability to store and quickly query large datasets). Conductor 104 may provide interconnectivity by acting as the centralized point of communication for third-party solutions and/or applications.

Robots 106 are execution agents that run processes built in designer 102. One commercial example of some embodiments of robots 106 is UiPath Robots™. Types of robots 106 may include, but are not limited to, attended robots 108 and unattended robots 110. Attended robots 108 are triggered by a user or user events and operate alongside a human user on the same computing system. Attended robots 108 may help the human user accomplish various tasks, and may be triggered directly by the human user and/or by user events. In the case of attended robots, conductor 104 may provide centralized process deployment and a logging medium. In certain embodiments, attended robots 108 can only be started from a “robot tray” or from a command prompt in a web application. Unattended robots 110 operate in an unattended mode in virtual environments and can be used for automating many processes, e.g., for high-volume, back-end processes and so on. Unattended robots 110 may be responsible for remote execution, monitoring, scheduling, and providing support for work queues. Both attended and unattended robots may automate various systems and applications including, but not limited to, mainframes, web applications, VMs, enterprise applications (e.g., those produced by SAP®, SalesForce®, Oracle®, etc.), and computing system applications (e.g., desktop and laptop applications, mobile device applications, wearable computer applications, etc.).

In some embodiments, robots 106 install the Microsoft Windows® Service Control Manager (SCM)-managed service by default. As a result, such robots 106 can open interactive Windows® sessions under the local system account, and have the rights of a Windows® service. In some embodiments, robots 106 can be installed in a user mode with the same rights as the user under which a given robot 106 has been installed.

Robots 106 in some embodiments are split into several components, each being dedicated to a particular task. Robot components in some embodiments include, but are not limited to, SCM-managed robot services, user mode robot services, executors, agents, and command line. SCM-managed robot services manage and monitor Windows® sessions and act as a proxy between conductor 104 and the execution hosts (i.e., the computing systems on which robots 106 are executed). These services are trusted with and manage the credentials for robots 106. A console application is launched by the SCM under the local system. User mode robot services in some embodiments manage and monitor Windows® sessions and act as a proxy between conductor 104 and the execution hosts. User mode robot services may be trusted with and manage the credentials for robots 106. A Windows® application may automatically be launched if the SCM-managed robot service is not installed. Executors may run given jobs under a Windows® session (e.g., they may execute workflows) and they may be aware of per-monitor dots per inch (DPI) settings. Agents may be Windows® Presentation Foundation (WPF) applications that display the available jobs in the system tray window. Agents may be a client of the service. Agents may request to start or stop jobs and change settings. Command line is a client of the service and is a console application that can request to start jobs and waits for their output. Splitting robot components can help developers, support users, and enable computing systems to more easily run, identify, and track what each robot component is executing. For example, special behaviors may be configured per robot component, such as setting up different firewall rules for the executor and the service. As a further example, an executor may be aware of DPI settings per monitor in some embodiments and, as a result, workflows may be executed at any DPI regardless of the configuration of the computing system on which they were created.

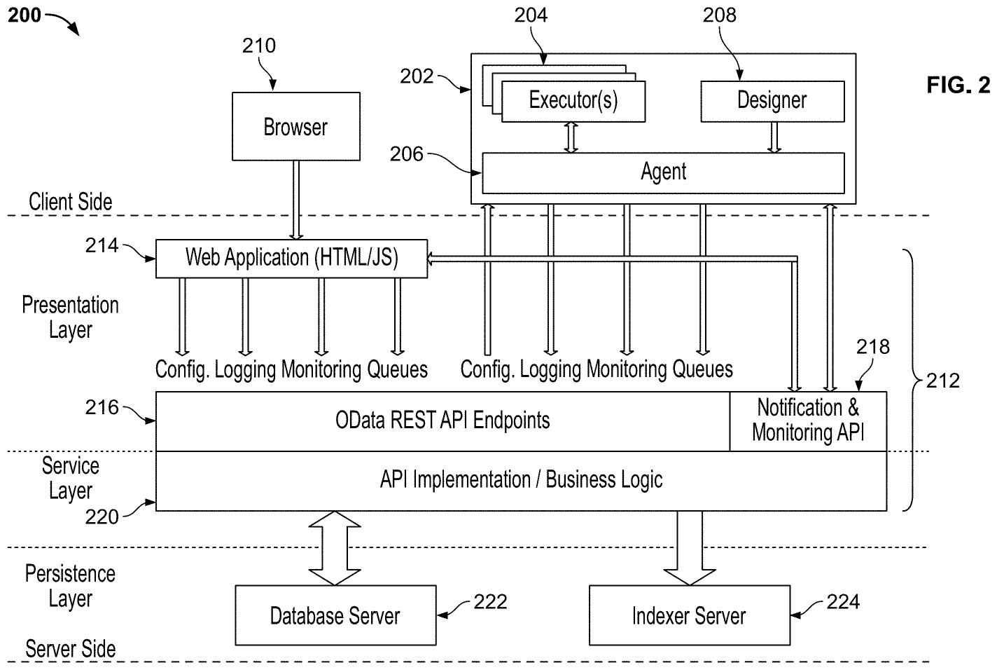

FIG. 2 shows an RPA system 200, in accordance with one or more embodiments. RPA system 200 may be, or may be part of, RPA system 100 of FIG. 1. It should be noted that the “client side”, the “server side”, or both, may include any desired number of computing systems without deviating from the scope of the invention.

As shown on the client side in this embodiment, computing system 202 includes one or more executors 204, agent 206, and designer 208. In other embodiments, designer 208 may not be running on the same computing system 202. An executor 204 (which may be a robot component as described above) runs a process and, in some embodiments, multiple business processes may run simultaneously. In this example, agent 206 (e.g., a Windows® service) is the single point of contact for managing executors 204.

In some embodiments, a robot represents an association between a machine name and a username. A robot may manage multiple executors at the same time. On computing systems that support multiple interactive sessions running simultaneously (e.g., Windows® Server 2012), multiple robots may be running at the same time (e.g., a high density (HD) environment), each in a separate Windows® session using a unique username.

Agent 206 is also responsible for sending the status of the robot (e.g., periodically sending a “heartbeat” message indicating that the robot is still functioning) and downloading the required version of the package to be executed. The communication between agent 206 and conductor 212 is initiated by agent 206 in some embodiments. In the example of a notification scenario, agent 206 may open a WebSocket channel that is later used by conductor 212 to send commands to the robot (e.g., start, stop, etc.).

As shown on the server side in this embodiment, a presentation layer comprises web application 214, Open Data Protocol (OData) Representative State Transfer (REST) Application Programming Interface (API) endpoints 216 and notification and monitoring API 218. A service layer on the server side includes API implementation/business logic 220. A persistence layer on the server side includes database server 222 and indexer server 224. Conductor 212 includes web application 214, OData REST API endpoints 216, notification and monitoring API 218, and API implementation/business logic 220.

In various embodiments, most actions that a user performs in the interface of conductor 212 (e.g., via browser 210) are performed by calling various APIs. Such actions may include, but are not limited to, starting jobs on robots, adding/removing data in queues, scheduling jobs to run unattended, and so on. Web application 214 is the visual layer of the server platform. In this embodiment, web application 214 uses Hypertext Markup Language (HTML) and JavaScript (JS). However, any desired markup languages, script languages, or any other formats may be used without deviating from the scope of the invention. The user interacts with web pages from web application 214 via browser 210 in this embodiment in order to perform various actions to control conductor 212. For instance, the user may create robot groups, assign packages to the robots, analyze logs per robot and/or per process, start and stop robots, etc.

In addition to web application 214, conductor 212 also includes a service layer that exposes OData REST API endpoints 216 (or other endpoints may be implemented without deviating from the scope of the invention). The REST API is consumed by both web application 214 and agent 206. Agent 206 is the supervisor of one or more robots on the client computer in this exemplary configuration.

The REST API in this embodiment covers configuration, logging, monitoring, and queueing functionality. The configuration REST endpoints may be used to define and configure application users, permissions, robots, assets, releases, and environments in some embodiments. Logging REST endpoints may be useful for logging different information, such as errors, explicit messages sent by the robots, and other environment-specific information, for example. Deployment REST endpoints may be used by the robots to query the package version that should be executed if the start job command is used in conductor 212. Queueing REST endpoints may be responsible for queues and queue item management, such as adding data to a queue, obtaining a transaction from the queue, setting the status of a transaction, etc. Monitoring REST endpoints monitor web application 214 and agent 206. Notification and monitoring API 218 may be REST endpoints that are used for registering agent 206, delivering configuration settings to agent 206, and for sending/receiving notifications from the server and agent 206. Notification and monitoring API 218 may also use WebSocket communication in some embodiments.

The persistence layer on the server side includes a pair of servers in this illustrative embodiment—database server 222 (e.g., a SQL server) and indexer server 224. Database server 222 in this embodiment stores the configurations of the robots, robot groups, associated processes, users, roles, schedules, etc. This information is managed through web application 214 in some embodiments. Database server 222 may also manage queues and queue items. In some embodiments, database server 222 may store messages logged by the robots (in addition to or in lieu of indexer server 224). Indexer server 224, which is optional in some embodiments, stores and indexes the information logged by the robots. In certain embodiments, indexer server 224 may be disabled through configuration settings. In some embodiments, indexer server 224 uses ElasticSearch®, which is an open source project full-text search engine. Messages logged by robots (e.g., using activities like log message or write line) may be sent through the logging REST endpoint(s) to indexer server 224, where they are indexed for future utilization.

RPA is typically implemented to automate processes with the goal of reducing costs, increasing productivity, or increasing quality. However, it is often difficult for organizations to determine whether implementing RPA to automate a particular process will, in practice, reduce costs and by how much. Embodiments described herein provide for the hierarchical assessment of processes to determine whether RPA should be implemented to automate the processes. Advantageously, embodiments described herein facilitate the decision making process for implementing RPA for automating processes, thereby avoiding the time and cost of implementing RPA when a process is not ready or suitable for automation via RPA.

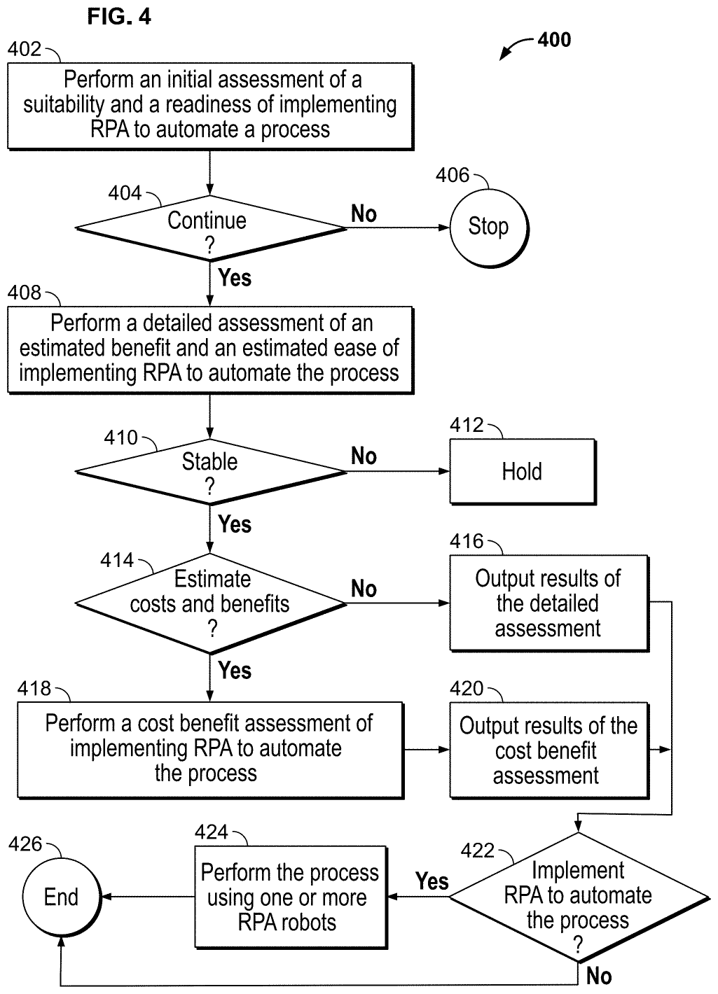

FIG. 4 is a method 400 for performing a hierarchical assessment for implementing RPA for automating a process, in accordance with one or more embodiments. The hierarchical assessment of method 400 comprises an initial assessment, a detailed assessment, and a cost benefit assessment. The assessments in method 400 are hierarchically applied such that the detailed assessment is only performed based on results of the initial assessment and the cost benefit analysis is only performed based on results of the detailed assessment.

At step 402, an initial assessment of a suitability and a readiness of implementing RPA to automate a process is performed to determine whether to invest more time to perform a detailed assessment of the process. The initial assessment is a high-level evaluation of the suitability and the readiness of the process for implementing RPA for automating the process based on input from a user. The user may be any user, and would typically be a lower level user (e.g., an employee of a company) that is not familiar with RPA and automation. A user interface is presented to guide the user to input answers to a plurality of questions relating to the suitability and readiness of implementing RPA to automate the process using visual aids and explanations. In one example, the user interface is part of an employee submission process that facilitates employee proposals of processes to automate. The initial assessment acts as a filter for processes that should not be automated with RPA, to therefore avoid spending the time for performing the detailed assessment.

The initial assessment evaluates the suitability and the readiness of the process for implementing RPA for automating the process based on user input received for a number of factors. In one embodiment, the factors for evaluating the suitability of the process for implementing RPA to automate the process may include how rule-based the process is, the digitization of the data input into the process, and the structure of the data input into the process and the factors for evaluating the readiness of the process for implementing RPA to automate the process may include upcoming changes to the process and the availability of documentation describing the process. Other factors are also contemplated for performing the initial assessment. In one embodiment, the user input is received as a selection of one of a plurality (e.g., 5) of choices for each factor, where each choice represents a degree for each factor. The plurality of choices may be a ranking on a Likert scale or any other suitable rating scale.

The initial assessment calculates an initial assessment score representing the determination of whether to consider implementing RPA and hence invest more time in the detailed assessment. In one embodiment, each of the plurality of choices is associated with a factor score (e.g., 1 through 5) and the initial assessment score may be calculated as a mean of the factor scores of the selected choices associated with the factors (for both suitability and readiness). The initial assessment determines that the process may be a good candidate and it would warrant performing the detailed assessment when the initial assessment score satisfies a threshold. In one embodiment, a suitability score representing the suitability of the process for being automated and a readiness score representing a readiness of the process for being automated may also be calculated, e.g., as a mean of the factor scores of the selected choices associated with their respective factors. In some embodiments, multiple choices may be selected for a factor (e.g., the types of documentation available), in which case the maximum value is used for calculating the scores.

In one embodiment, regardless of the initial assessment score, the initial assessment recommends not to implement RPA to automate the process in response to the occurrence of an exception. One example of an exception is where the user selects a choice indicating a lowest degree of the digitization of the input of the process (e.g., a factor score of 1), which would indicate that the input is paper-based (i.e., not digital). Another example of an exception is if the readiness score is below a threshold (e.g., 2).

At step 404, it is determined whether to continue with the hierarchical assessment based on the results of the initial assessment. The determination may be made based on input from the user considering the recommendation of whether to implement RPA for automating the process from the initial assessment. If it is determined to not continue with the hierarchical assessment, method 400 proceeds to step 406 and the hierarchical assessment stops. Accordingly, a user may be decided to not implement RPA to automate the process or to hold off on the decision of whether to implement RPA to automate the process until a later time when circumstances may change. If it is determined to continue with the hierarchical assessment, method 400 proceeds to step 408.

At step 408, in response to determining to continue the hierarchical assessment based on the results of the initial assessment, a detailed assessment of an estimated benefit and an estimated ease of implementing RPA to automate the process is performed. The detailed assessment is a more comprehensive assessment of the process for implementing RPA for automating the process than the initial assessment. The detailed assessment is a detailed evaluation of the estimated benefit and the estimated ease of implementation, as well as a feasibility and an estimated automation potential of implementing RPA for automating the process, based on input from a user. The user would typically be a higher level user (e.g., an owner of the processes or a business analyst) that is familiar with RPA and automation. A user interface is presented to guide the user to input answers to several relatively detailed questions relating to the feasibility, automation potential, ease of implementation, and estimated benefits of implementing RPA for automating the process. The detailed assessment provides a better determination as to whether to implement RPA to automate the process.

The detailed assessment evaluates an automation feasibility of the process, an automation potential of the process, ease of implementation of automating the process, and an estimated benefit of automating the process based on user input received for a number of factors. The factors may comprise one or more of process stability, applications stability, the structure of data input into the process, process variability, process length, and the number of applications needed to execute the process. Other factors are also contemplated for performing the detailed assessment. Process stability represents the expected changes to the way the process is performed. Applications stability represents the expected changes to the applications over which the process runs. Process variability represents the variations of paths to complete the process. Process length represents the number of steps or activities to complete the process. In one embodiment, the user input is received as a selection of one of a plurality (e.g., 5) of choices for each factor, where each choice represents the degree for each factor and is associated with a factor score.

The evaluation of the automation feasibility evaluates whether it is feasible to automate the process at the current time. The automation feasibility of the process may be evaluated based on factors comprising process stability and applications stability. The user input is received from a plurality of choices relating to the severity of changes to the process or to applications running the process (e.g., ranging from no change to major change). The evaluation of the automation feasibility of the process acts as an exception based on the user input for process stability and/or applications stability. For instance, in one embodiment, an exception occurs when user input is received that selects the highest degree of change (e.g., major change is expected) for process stability or for applications stability, and the detailed assessment recommends to not implement RPA to automate the process at this time. The output of the evaluation of the automation feasibility is a binary indication that yes it is feasible to automate the process or no it is not feasible to automate the process at this time.

The evaluation of the ease of implementation evaluates the level of difficulty in implementing automation of the process. The ease of implementation of automating the process may be evaluated based on factors comprising process stability, applications stability, the structure of data input into the process, process variability, process length, and number of applications needed to execute the process. The factor score for each factor is weighted and the weighted factor scores are combined (e.g., summed) to calculate a baseline penalty. In one embodiment, the factors of structure of input data and process variability are assigned the most weight. In one embodiment, an ease of implementation score is calculated as 1−(Baseline Penalty×Multiplier 1×Multiplier 2). Multiplier 1 has a value of 1 if all data input into the process is natively digital and a value of 1.2 if any of the data input into the process is not natively digital (e.g., scanned). Multiplier 2 has a value of 1 if no applications are accessed via thin clients and a value equal to the percentage of applications access via thin clients multiplied by 0.6 plus 1. For example, where 100% of applications are accessed via thin clients, multiplier 2 is 1.6. In another example, where one out of three applications are accessed via thin clients, multiplier 2 is 1.2. In one embodiment, a correction is applied so that an ease of implementation score below zero is set to zero. The output of the evaluation of the ease of implementation is an ease of implementation score (e.g., represented as a percentage) representing the level of difficulty in implementing automation of the process. The process may be categorized based on the ease of implementation score. For example, a score between 65% and 100% may indicate easy implementation of RPA, a score between 35% and 65% may indicate medium difficulty for implementing RPA, and a score between 0% and 35% may indicate difficult implementation of RPA.

The evaluation of the automation potential evaluates how suitable the process is for automating (and hence whether an RPA robot can perform it) and approximates the degree to which a process can be automated (e.g., an automation potential of 80% means that 80% of the process/transactions running through the process can be automated). The automation potential of the process may be evaluated based on factors comprising the structure of data input into the process and process variability. The factor score of each factor is weighted by respective weights W1 and W2 (e.g., percentages), and an automation potential score is calculated. In one embodiment, the automation potential score is calculated as shown in Equation 1:

Automation Potential=% of Input Data that is Digital×(1−W1×Structure of the Input Data−W2×Process Variability). (Equation 1)

The automation potential calculation starts from the assumption that if 100% of the input data into a process is digital, then 100% of the process could theoretically be automated. Then penalties are applied for the structure of the input data (the more unstructured the data the less of the process can be automated) and for the process variability (the more paths there are to complete the process the less likely it is that all could be automated). The automation potential score represents how suitable the process is for automation. The automation potential is a proxy representing the percentage of the process that is automatable.

The estimated benefit of automating the process is a quantification of the amount of time saved by automating the process and the cost saved by automating the process over a given time period (e.g., 1 or 2 years). The amount of time and cost saved by automating the process are calculated based on the baseline time to manually perform the process (e.g., in hours), the time to rework the process due to errors (e.g., in hours), and the time to audit/review the process (e.g., in hours), the total of which is multiplied by the automation potential to yield the amount of hours that could be saved by automating. The baseline time to manually perform the process is calculated as the frequency of a time period that the process is manually performed (e.g., daily, weekly, bi-weekly, monthly, quarterly, yearly, etc.) multiplied by the volume of work completed during the time period multiplied by the average processing time per transaction. The time to rework the process due to errors is calculated as the volume of work completed during the time period multiplied by the error rate multiplied by the average time to rework. The time to audit/review the process is calculated as the volume of work completed during the time period multiplied by the audit/review rate multiplied by the average time to audit/review. The variables used to calculate the baseline time, the time to rework the process, and the time to audit/review the process may be received as user input. The amount of time (e.g., in hours) saved by automating the process is calculated as the sum of the baseline time to complete the process, the time to rework the process due to errors, and the time to audit/review the process, the sum of which is multiplied by the Automation Potential. The cost (e.g., in dollars) saved by automating the process is calculated as the product of the number of hours saved by automating the process and the cost (e.g., per hour) of a user (e.g., an employee) to manually perform the process.

At step 410, it is determined whether the process is stable based on the automation feasibility of the detailed assessment. The process is determined to be not stable where an exception occurs in the automation feasibility and method 400 proceeds to step 412 where the hierarchical assessment is put on hold. Otherwise, the process is determined to be stable and method 400 proceeds to step 414, where it is determined whether to estimate the cost and the benefits. Where a user (e.g., an organization) determines to estimate the cost and the benefits, method 400 proceeds to step 418. Otherwise, method 400 proceeds to step 416.

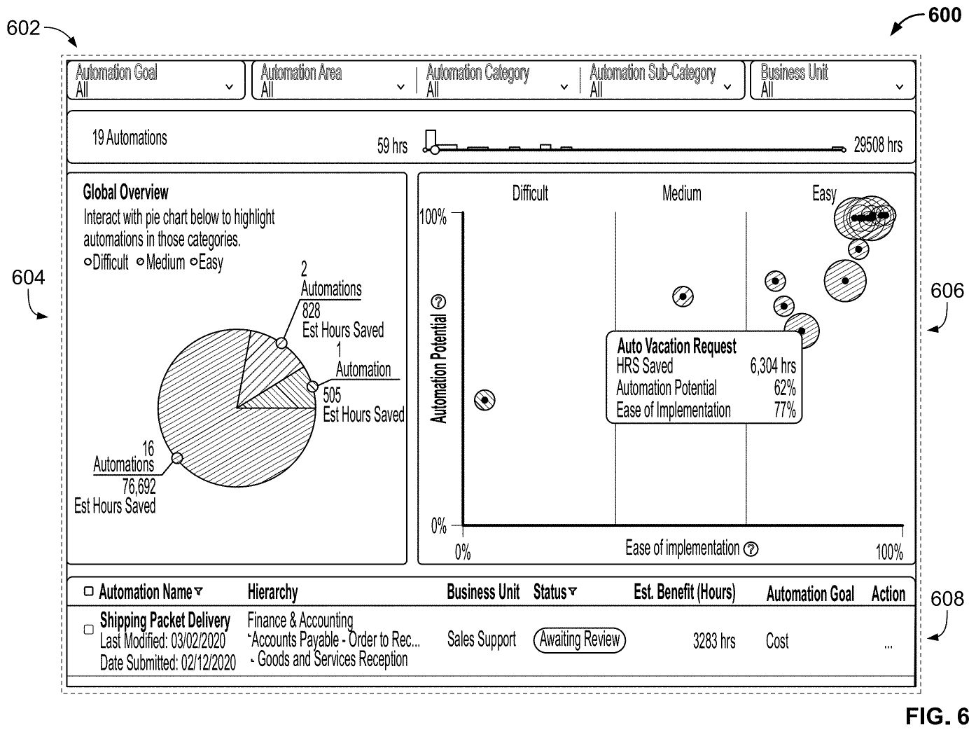

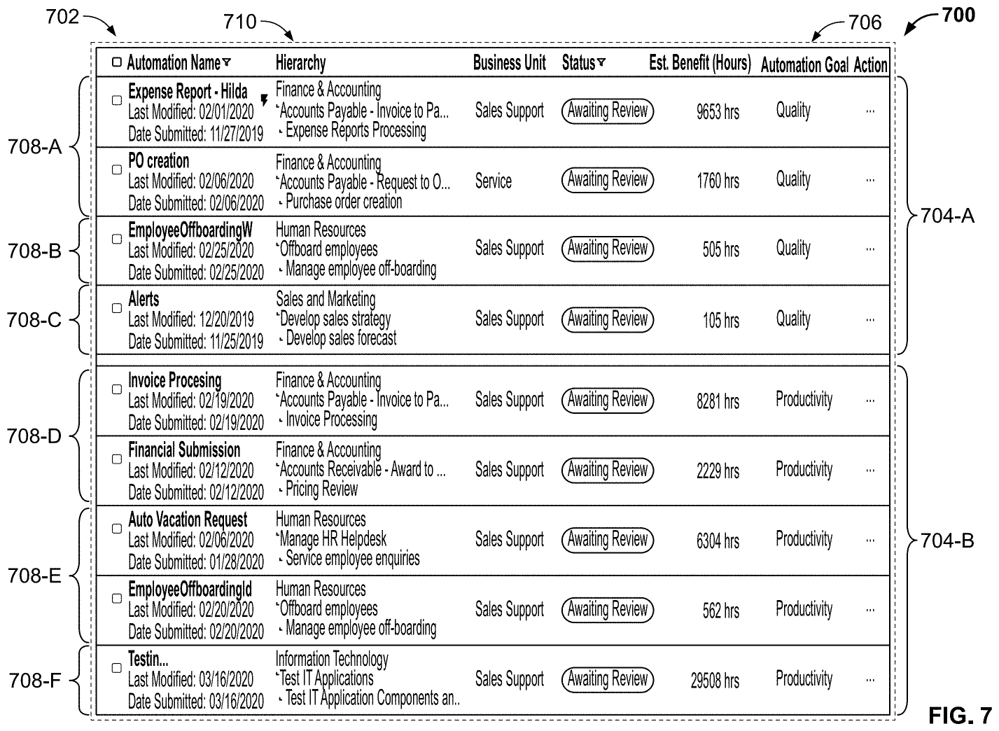

At step 416, results of the detailed assessment are output. The results of the detailed assessment may be output by, for example, displaying the results on a display device of a computer system or by storing the results on a memory or storage of a computer system. In one example, the results of the detailed assessment are displayed on one or more dashboards. The dashboard may show the estimated benefits (e.g., hours or cost saved over a given time period by automating the process) and the ease of implementation (e.g., easy, medium, or difficult, which is a proxy for cost to implement) of implementing RPA for automating the process. In one embodiment, the dashboard depicts the process, with other assessed processes, according to a prioritized recommendation based on the ease of implementation and the estimated benefit (e.g., in hours). For example, the processes may be grouped according to ease of implementation and, within each group, the processes are sorted from highest estimated benefit to lowest. The detailed assessment therefore provides the user with information indicating the cost that can be saved and how difficult it will be to implement RPA, and hence, provides the user with an indication of whether it is worth automating the process. Exemplary dashboards are shown in FIGS. 6 and 7, which are described in more detail below.

At step 418, in response to determining to continue with the hierarchical assessment based on the results of the detailed assessment, a cost benefit assessment of implementing RPA to automate the process is performed. The cost benefit assessment provides a refined estimate of the benefits and the costs of implementing RPA to automate the process over a duration of, e.g., 2 years. The cost benefit assessment is performed, at least in part, using input from the user received during the detailed assessment. The cost benefit assessment determines a recommended number of RPA robots to deploy to perform the process and calculates the benefits and costs of implementing RPA to automate the process based on the recommended number of RPA robots as well as other inputs.

In one embodiment, a number of unattended RPA robots is estimated based on the total volume of transactions that could be handled by a robot and user input regarding robot working assumptions. The total volume of transactions is calculated as the volume of transactions performed manually by a user, multiplied by the automation potential. The user input regarding robot working assumptions includes the number of hours worked by a robot per day, the number of days worked by a robot per year, and a speed factor (i.e., how much faster a robot can be compared to the average handling time for a user (normal work, review, and audit)). The number of unattended RPA robots according to Equation 2:

Number of Unattended Robots=(Average Handling time by robot per transaction in minutes×Number of transaction that could be handled by a robot)/60/Number of days worked by a robot per year/Number of working worked by a robot per day (Equation 2)

In one example, the total volume of transactions performed manually in the process per year is 360 (computed based on user input by multiplying average volume per selected frequency by the frequency). The average handling time by a user is 66.8 minutes and the robot is 2 times faster than a user (received as user input during the cost benefit assessment), resulting in an average handling time of the robot of 66.8/2=33.4. The robot can work 300 days per year and 5 hours per day (received as user input during the cost benefit assessment) and the automation potential is 80% (calculated according to Equation 1 during the detailed assessment). In some embodiments, the automation potential can be overwritten by user input during the cost benefit assessment. Accordingly, the robot can handle 360×80%=288 transactions and the number of unattended robots needed is (288×33.4 minutes)/60/5/300=0.10688, which is rounded up to the next integer. Therefore, 1 unattended robot could handle the work in this example.

In one embodiment, the number of attended robots is estimated as the number of users (e.g., employees) performing the process, as it is assumed that each employee will need to have 1 robot installed of their machine to be able to trigger it. The number of employees is received as user input during the detailed assessment.

The cost benefit analysis evaluates the estimated benefits and the costs of implementing RPA to automate the process to determine an estimation of net benefit over a given time period (e.g., 2 years). The estimated benefit of implementing RPA to automate the process is calculated as the automation potential score multiplied by the cost to perform the process (without implementing RPA to automate the process). The automation potential score may be determined during the detailed assessment or may be defined by the user as user input. The costs of implementing RPA to automate the process is calculated as the sum of the costs of implementing RPA, licensing the estimated number of robots, software costs (other software licenses for implementing RPA), support costs (based on the number of hours for users or employees to provide support), infrastructure costs, etc. The estimated net benefit is calculated as the difference of the estimated benefit from the costs. At step 420, results of the cost benefit assessment are output. In one embodiment, the results of the cost benefit assessment may be output by, for example, displaying the results of the cost benefit assessment on a display device of a computer system or storing the results of the cost benefit assessment on a memory or storage of a computer system. In one embodiment, the results are displayed in one or more dashboards. In one embodiment, the dashboard depicts the process, with other assessed processes, according to a prioritized recommendation based net benefit, calculated as the estimated benefit (expressed monetarily) subtracted from estimated costs (expressed monetarily). For example, the dashboard may depict the processes sorted from highest net benefit to lowest. Exemplary dashboards are shown in FIGS. 6 and 7, which are described in more detail below.

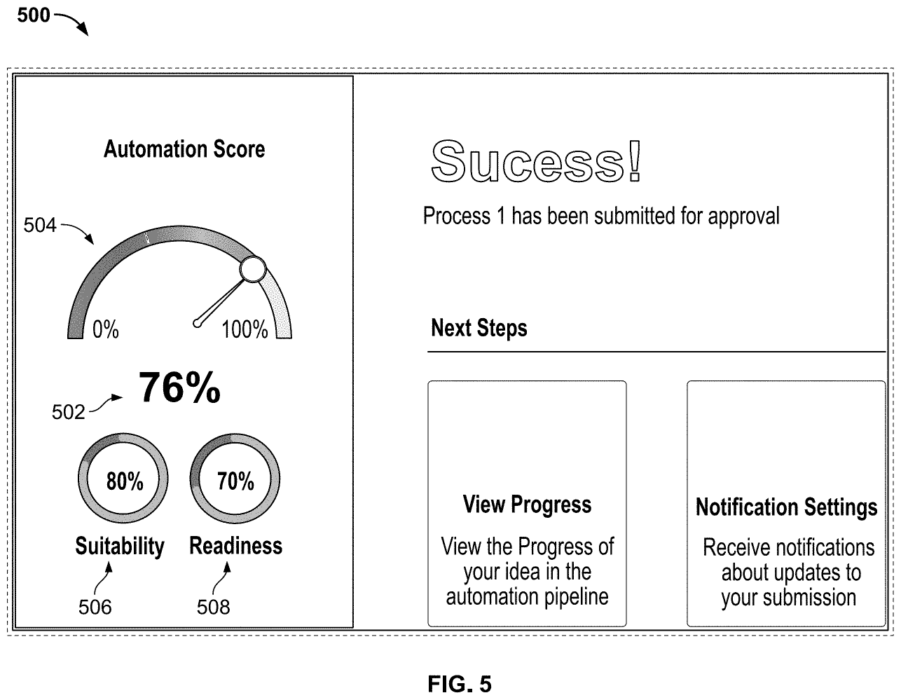

At step 422, based on the results output at step 416 or step 420, it is determined whether to implement RPA to automate the process. For example, a user may evaluate the results output at step 416 or step 420 to determine whether to implement RPA to automate the process. If it is determined to implement RPA to automate the process at step 422, method 400 proceeds to step 424 and the process is implemented using one or more RPA robots. The process may be automatically or semi-automatically (using input from a user) performed. In one embodiment, where the cost benefit assessment is performed, the process may be performed using the number of robots calculated by the cost benefit assessment. Method 400 then ends at step 426. If it is determined to not implement RPA to automate the process at step 422, method 400 ends at step 426. FIG. 5 shows an exemplary user interface 500 for displaying results of the initial assessment, in accordance with one or more embodiments. As shown in FIG. 5, user interface 500 shows an initial assessment score 502 as a percentage, which is also shown in gauge chart 504. The suitability score is shown in doughnut chart 506 and the readiness score is shown in doughnut chart 508.

FIG. 6 shows an exemplary dashboard 600 for displaying results of the detailed assessment, in accordance with one or more embodiments. Dashboard 600 comprises user selectable field 602 for selecting an automation goal, which allows for the comparison of processes associated with the selected automation goal. Dashboard 600 shows a pie chart 604 of the ease of implementation of processes for the selected automation goal. Each portion of pie chart 604 may correspond to a level of ease of implementation and may be color coded to represent the level of ease of implementation. For example, a portion of pie chart 604 of be colored red to represent processes with a difficult level of implementation, yellow to represent processes with a medium level of implementation, and green to represent processes with an easy level of implementation. A user may interact with pie chart 604 to view various details, such as, e.g., the number of processes corresponding to each portion, estimated hours saved for processes corresponding to each portion, or other information. Dashboard 600 also shows bubble chart 606 comparing ease of implementation (x-axis) with automation potential (y-axis) of processes. Each bubble in bubble chart 606 represents a process. The size of each bubble in bubble chart 606 represents the estimated benefits (e.g., in hours) from implementing RPA to automate that process, where the larger the bubble, the bigger the estimated benefit. A user may interact with bubble chart 606 to view various details of the process, such as, e.g., estimated benefits (e.g., hours saved), ease of implementation percentage, automation potential percentage, or other information. Dashboard 600 also shows table 608 showing various details of each process. Additional details of table 608 are discussed with respect to FIG. 7.

FIG. 7 shows an exemplary dashboard 700 for displaying a table 702 of results of the detailed assessment, in accordance with one or more embodiments. Table 702 shown in dashboard 700 is table 608 of FIG. 6. Table 702 shows details of processes grouped into groups 704-A and 704-B (collectively referred to as groups 704) each associated with a selected automation goal, as identified in automation goal column 706. As shown in FIG. 7, group 704-A is associated with the automation goal quality and group 704-B is associated with the automation goal productivity. Within each group 704, the processes are further grouped by sub-groups 708-A, 708-B, 708-C, 708-D, 708-E, and 708-F (collectively referred to as sub-groups 708) each associated with a functional area reflecting the role performed by the processes in an organization, as identified in hierarchy column 710. As shown in FIG. 7, sub-group 708-A is associated with the functional area of finance & accounting, sub-group 708-B is associated with human resources, sub-group 708-C is associated with sales and marketing, sub-group 708-D is associated with finance & accounting, sub-group 708-E is associated with human resources, and sub-group 708-F is associated with information technology. Advantageously, table 702 provides a prioritization recommendation for automating processes by grouping processes into groups 704 and sub-groups 708, thereby allowing users to compare processes from same groups 704 and sub-groups 708.

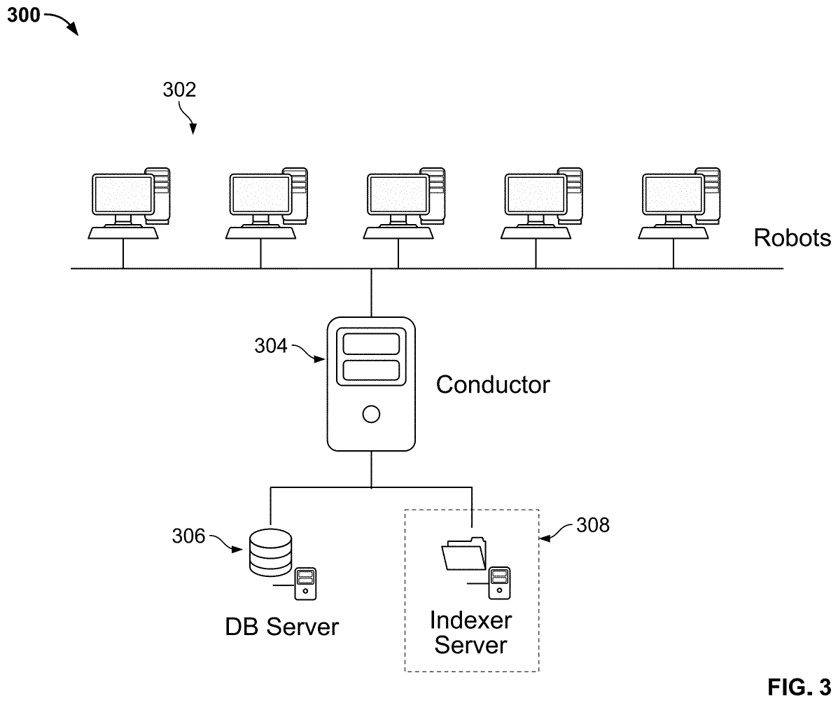

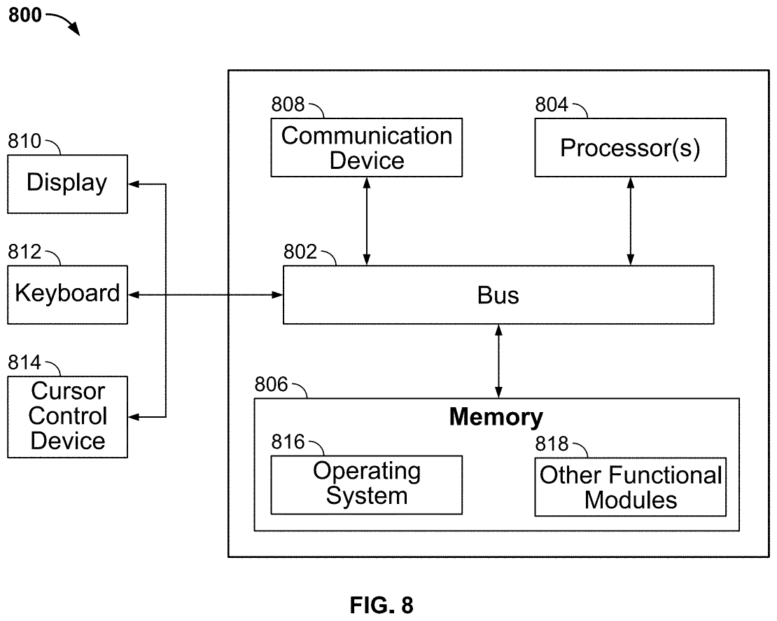

FIG. 8 is a block diagram illustrating a computing system 800 configured to execute the methods, workflows, and processes described herein, including FIGS. 1-4, according to an embodiment of the present invention. In some embodiments, computing system 800 may be one or more of the computing systems depicted and/or described herein. Computing system 800 includes a bus 802 or other communication mechanism for communicating information, and processor(s) 804 coupled to bus 802 for processing information. Processor(s) 804 may be any type of general or specific purpose processor, including a Central Processing Unit (CPU), an Application Specific Integrated Circuit (ASIC), a Field Programmable Gate Array (FPGA), a Graphics Processing Unit (GPU), multiple instances thereof, and/or any combination thereof. Processor(s) 804 may also have multiple processing cores, and at least some of the cores may be configured to perform specific functions. Multi-parallel processing may be used in some embodiments.

Computing system 800 further includes a memory 806 for storing information and instructions to be executed by processor(s) 804. Memory 806 can be comprised of any combination of Random Access Memory (RAM), Read Only Memory (ROM), flash memory, cache, static storage such as a magnetic or optical disk, or any other types of non-transitory computer-readable media or combinations thereof. Non-transitory computer-readable media may be any available media that can be accessed by processor(s) 804 and may include volatile media, non-volatile media, or both. The media may also be removable, non-removable, or both.

Additionally, computing system 800 includes a communication device 808, such as a transceiver, to provide access to a communications network via a wireless and/or wired connection according to any currently existing or future-implemented communications standard and/or protocol.

Processor(s) 804 are further coupled via bus 802 to a display 810 that is suitable for displaying information to a user. Display 810 may also be configured as a touch display and/or any suitable haptic I/O device.

A keyboard 812 and a cursor control device 814, such as a computer mouse, a touchpad, etc., are further coupled to bus 802 to enable a user to interface with computing system. However, in certain embodiments, a physical keyboard and mouse may not be present, and the user may interact with the device solely through display 810 and/or a touchpad (not shown). Any type and combination of input devices may be used as a matter of design choice. In certain embodiments, no physical input device and/or display is present. For instance, the user may interact with computing system 800 remotely via another computing system in communication therewith, or computing system 800 may operate autonomously.

Memory 806 stores software modules that provide functionality when executed by processor(s) 804. The modules include an operating system 816 for computing system 800 and one or more additional functional modules 818 configured to perform all or part of the processes described herein or derivatives thereof.

One skilled in the art will appreciate that a “system” could be embodied as a server, an embedded computing system, a personal computer, a console, a personal digital assistant (PDA), a cell phone, a tablet computing device, a quantum computing system, or any other suitable computing device, or combination of devices without deviating from the scope of the invention. Presenting the above-described functions as being performed by a “system” is not intended to limit the scope of the present invention in any way, but is intended to provide one example of the many embodiments of the present invention. Indeed, methods, systems, and apparatuses disclosed herein may be implemented in localized and distributed forms consistent with computing technology, including cloud computing systems.

It should be noted that some of the system features described in this specification have been presented as modules, in order to more particularly emphasize their implementation independence. For example, a module may be implemented as a hardware circuit comprising custom very large scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices, graphics processing units, or the like. A module may also be at least partially implemented in software for execution by various types of processors. An identified unit of executable code may, for instance, include one or more physical or logical blocks of computer instructions that may, for instance, be organized as an object, procedure, or function. Nevertheless, the executables of an identified module need not be physically located together, but may include disparate instructions stored in different locations that, when joined logically together, comprise the module and achieve the stated purpose for the module. Further, modules may be stored on a computer-readable medium, which may be, for instance, a hard disk drive, flash device, RAM, tape, and/or any other such non-transitory computer-readable medium used to store data without deviating from the scope of the invention. Indeed, a module of executable code could be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

The foregoing merely illustrates the principles of the disclosure. It will thus be appreciated that those skilled in the art will be able to devise various arrangements that, although not explicitly described or shown herein, embody the principles of the disclosure and are included within its spirit and scope. Furthermore, all examples and conditional language recited herein are principally intended to be only for pedagogical purposes to aid the reader in understanding the principles of the disclosure and the concepts contributed by the inventor to furthering the art, and are to be construed as being without limitation to such specifically recited examples and conditions. Moreover, all statements herein reciting principles, aspects, and embodiments of the disclosure, as well as specific examples thereof, are intended to encompass both structural and functional equivalents thereof. Additionally, it is intended that such equivalents include both currently known equivalents as well as equivalents developed in the future.

What is claimed is:

1. A method for performing a hierarchical assessment of a process for implementing robotic process automation (RPA) for automating the process, comprising:
performing an initial assessment of a suitability and a readiness of implementing RPA to automate the process;
in response to a determination to continue the hierarchical assessment based on results of the initial assessment, performing a detailed assessment of an estimated benefit and an estimated ease of implementing RPA to automate the process; and
in response to a determination to continue the hierarchical assessment based on results of the detailed assessment, performing a cost benefit assessment to determine a number of RPA robots to deploy to perform the process.

2. The method of claim 1, further comprising:
implementing and performing the process using the number of the RPA robots.

3. The method of claim 1, wherein performing a detailed assessment of an estimated benefit and an estimated ease of implementing RPA to automate the process comprises:
estimating the ease of implementing RPA to automate the process as one of a plurality of categories;
estimating an automation potential representing a percentage of the process than can be automated; and
estimating an amount of time saved by automating the process and cost saved by automating the process based on the estimated automation potential.

4. The method of claim 3, wherein estimating an amount of time saved by automating the process and cost saved by automating the process based on the estimated automation potential comprises:
estimating the amount of time saved by automating the process as a product between the estimated automation potential and a time to manually perform the process.

5. The method of claim 3, wherein estimating an amount of time saved by automating the process and cost saved by automating the process based on the estimated automation potential comprises:
calculating the cost saved by automating the process as a product of the amount of time saved by automating the process and a cost of a user to manually perform the process.

6. The method of claim 1, wherein performing a detailed assessment of an estimated benefit and an estimated ease of implementing RPA to automate the process comprises:
determining not to implement RPA to automate the process based on a severity of expected changes to the process or to applications running the process.

7. The method of claim 1, wherein performing an initial assessment of a suitability and a readiness of implementing RPA to automate the process comprises:
determining not to implement RPA to automate the process based on data input into the process not being digital.

8. The method of claim 1, wherein performing a cost benefit assessment to determine a number of RPA robots to deploy to perform the process comprises:
determining the number of RPA robots based on inputs and outputs of the detailed assessment and user inputs.

9. The method of claim 1, further comprising:
displaying a dashboard of results of one or more of the initial assessment, the detailed assessment, and the cost benefit assessment.

10. The method of claim 9, wherein displaying a dashboard of results of one or more of the initial assessment, the detailed assessment, and the cost benefit assessment comprises:
displaying a table of results of the detailed assessment for a set of processes including the process, wherein the set of processes in the table are grouped into groups based on automation goal and, within each group, the set of processes are grouped into sub-groups based on functional area.

11. An apparatus comprising:
a memory storing computer instructions for performing a hierarchical assessment of a process for implementing robotic process automation (RPA) for automating the process; and
at least one processor configured to execute the computer instructions, the computer instructions configured to cause the at least one processor to perform operations of:
performing an initial assessment of a suitability and a readiness of implementing RPA to automate the process;
in response to a determination to continue the hierarchical assessment based on results of the initial assessment, performing a detailed assessment of an estimated benefit and an estimated ease of implementing RPA to automate the process; and
in response to a determination to continue the hierarchical assessment based on results of the detailed assessment, performing a cost benefit assessment to determine a number of RPA robots to deploy to perform the process.

12. The apparatus of claim 11, the operations further comprising:
implementing and performing the process using the number of the RPA robots.

13. The apparatus of claim 11, wherein performing a detailed assessment of an estimated benefit and an estimated ease of implementing RPA to automate the process comprises:
estimating the ease of implementing RPA to automate the process as one of a plurality of categories;
estimating an automation potential representing a percentage of the process than can be automated; and
estimating an amount of time saved by automating the process and cost saved by automating the process based on the estimated automation potential.

14. The apparatus of claim 13, wherein estimating an amount of time saved by automating the process and cost saved by automating the process based on the estimated automation potential comprises:
estimating the amount of time saved by automating the process as a product between the estimated automation potential and a time to manually perform the process.

15. The apparatus of claim 13, wherein estimating an amount of time saved by automating the process and cost saved by automating the process based on the estimated automation potential comprises:
calculating the cost saved by automating the process as a product of the amount of time saved by automating the process and a cost of a user to manually perform the process.

16. A computer program embodied on a non-transitory computer-readable medium for performing a hierarchical assessment of a process for implementing robotic process automation (RPA) for automating the process, the computer program configured to cause at least one processor to perform operations comprising:
performing an initial assessment of a suitability and a readiness of implementing RPA to automate the process;
in response to a determination to continue the hierarchical assessment based on results of the initial assessment, performing a detailed assessment of an estimated benefit and an estimated ease of implementing RPA to automate the process; and
in response to a determination to continue the hierarchical assessment based on results of the detailed assessment, performing a cost benefit assessment to determine a number of RPA robots to deploy to perform the process.

17. The computer program of claim 16, wherein performing a detailed assessment of an estimated benefit and an estimated ease of implementing RPA to automate the process comprises:
determining not to implement RPA to automate the process based on a severity of expected changes to the process or to applications running the process.

18. The computer program of claim 16, wherein performing an initial assessment of a suitability and a readiness of implementing RPA to automate the process comprises:
determining not to implement RPA to automate the process based on data input into the process not being digital.

19. The computer program of claim 16, wherein performing a cost benefit assessment to determine a number of RPA robots to deploy to perform the process comprises:
determining the number of RPA robots based on inputs and outputs of the detailed assessment and user inputs.

20. The computer program of claim 16, the operations further comprising:
displaying a table of results of the detailed assessment for a set of processes including the process, wherein the set of processes in the table are grouped into groups based on automation goal and, within each group, the set of processes are grouped into sub-groups based on functional area.
